(19) United States
(12) Patent Application Publication
(10) Pub. No.: US 2024/0279952 A1
(43) Pub. Date: Aug. 22, 2024

(54) Transmission Device and Pool Cleaning Robot

(71) Applicant: XINGMAI INNOVATION TECHNOLOGY(SUZHOU) CO., LTD., Suzhou (CN)

(72) Inventor: Shilei ZHANG, Suzhou (CN)

(21) Appl. No.: 18/234,395

(22) Filed: Aug. 16, 2023

Related U.S. Application Data
(63) Continuation of application No. PCT/CN2023/086048, filed on Apr. 3, 2023.

(30) Foreign Application Priority Data
Feb. 16, 2023 (CN) 202320232759.7

(51) Int. Cl. E04H 4/16; A46B 13/00; A46B 13/02; B62D 55/06; B62D 55/12; B62D 55/24; F16H 37/06

(52) U.S. Cl. CPC E04H 4/1654; A46B 13/001; A46B 13/02; B62D 55/06; B62D 55/12; B62D 55/24; F16H 37/065; A46B 2200/3073

(57) ABSTRACT

Some embodiments of the present disclosure provide a transmission device and a pool cleaning robot. The transmission device includes a driving member, a first driven member, and a second driven member; where an output end of the driving member is configured to be in driving connection with a wheel assembly of the pool cleaning robot; the first driven member is in driving connection with the wheel assembly, where an output end of the first driven member is configured to be connected with a first cleaning member of the pool cleaning robot, and the wheel assembly drives the first driven member to rotate; and the second driven member is in driving connection with the wheel assembly, where an output end of the second driven member is configured to be connected with a second cleaning member of the pool cleaning robot, and the wheel assembly drives the second driven member to rotate.

### CROSS-REFERENCE TO RELATED APPLICATIONS

The present disclosure is a national stage application of International Patent Application No. PCT/CN2023/086048, which is filed on Apr. 3, 2023, and claims priority to Chinese Patent Application No. 202320232759.7, filed on Feb. 16, 2023 and entitled “Transmission Device and Pool Cleaning Robot”, the contents of which are hereby incorporated by reference in its entirety.

### TECHNICAL FIELD

The disclosure relates to a technical field of pool cleaning robots. and in particular to a transmission device and a pool cleaning robot.

### BACKGROUND

With the economy developing and the technology advancing, a pool cleaning robot gradually takes a role in daily life and increasingly grows popular. A transmission device, a significant part of the pool cleaning robot, primarily serves to drive the pool cleaning robot to move.

In the related art, a driving wheel and a ground cleaning rolling brush of the pool cleaning robot are driven by different transmission devices, respectively, leading to a complex structure. Moreover, the pool cleaning robot can merely clean the bottom of a pool, and thus has a single cleaning function and limited use occasions.

### SUMMARY

Some embodiments of the present disclosure provide a transmission device. The transmission device is configured on a body, and the transmission device includes:
a driving member, where an output end of the driving member is configured to be in driving connection with a wheel assembly of a pool cleaning robot, so that the driving member is capable of driving the wheel assembly to rotate;
a first driven member, where the first driven member is in driving connection with the wheel assembly, an output end of the first driven member is configured to be connected with a first cleaning member of the pool cleaning robot, and the wheel assembly drives the first driven member to rotate, so that the first driven member drives the first cleaning member to rotate; and
a second driven member, where the second driven member is in driving connection with the wheel assembly, an output end of the second driven member is configured to be connected with a second cleaning member of the pool cleaning robot, and the wheel assembly drives the second driven member to rotate, so that the second driven member drives the second cleaning member to rotate.

In some embodiments, the wheel assembly includes a first wheel, a second wheel, and a first conveyor belt, and the first wheel is in transmission connection with the second wheel through the first conveyor belt, and the output end of the driving member is in driving connection with the first wheel.

In some embodiments, the transmission device further includes a first gear, and the output end of the driving member is connected with the first gear, and the first gear is engaged with the first wheel.

In some embodiments, the second driven member includes a second gear, a first rotary disc, a third gear, a second rotary disc, and a second conveyor belt, where the second gear is connected with the first rotary disc, the third gear is connected with the second rotary disc, the first rotary disc is in transmission connection with the second rotary disc through the second conveyor belt, and the second gear is engaged with the second wheel, and the third gear is applied to connecting with the second cleaning member.

In some embodiments, the second gear is configured coaxial with the first rotary disc, and the third gear is configured coaxial with the second rotary disc.

In some embodiments, the second driven member further includes a fourth gear, where the fourth gear is engaged with the third gear, and the fourth gear is connected with the second cleaning member, so that the third gear is connected with the second cleaning member through the fourth gear.

In some embodiments, the second driven member further includes a fifth gear, where the fifth gear is configured between the third gear and the fourth gear, and the fifth gear is engaged with the third gear, and the fifth gear is engaged with the fourth gear.

In some embodiments, the first driven member includes a sixth gear and a seventh gear, where the sixth gear is engaged with the second wheel, the sixth gear is engaged with the seventh gear, and the seventh gear is connected with the first cleaning member.

In some embodiments, the first driven member further includes an eighth gear, where the eighth gear is configured between the sixth gear and the seventh gear, and the eighth gear is engaged with the sixth gear, and the eighth gear is engaged with the seventh gear.

Some embodiments of the present disclosure further provide a pool cleaning robot. The pool cleaning robot includes a body, a first cleaning member, a second cleaning member, a wheel assembly and a transmission device, where the transmission device is configured on the body, and the transmission device includes:
a driving member, where an output end of the driving member is configured to be in driving connection with the wheel assembly, so that the driving member is capable of driving the wheel assembly to rotate;
a first driven member, where the first driven member is in driving connection with the wheel assembly, an output end of the first driven member is configured to be connected with the first cleaning member, and the wheel assembly drives the first driven member to rotate, so that the first driven member drives the first cleaning member to rotate: and
a second driven member, where the second driven member is in driving connection with the wheel assembly, an output end of the second driven member is configured to be connected with the second cleaning member, and the wheel assembly drives the second driven member to rotate, so that the second driven member drives the second cleaning member to rotate.

In some embodiments, wherein the wheel assembly includes a first wheel, a second wheel, and a first conveyor belt, wherein the first wheel is in transmission connection with the second wheel through the first conveyor belt, and the output end of the driving member is in driving connection with the first wheel.

In some embodiments, wherein the transmission device further includes a first gear, wherein the output end of the driving member is connected with the first gear, and the first gear is engaged with the first wheel.

In some embodiments, wherein the second driven member includes a second gear, a first rotary disc, a third gear, a second rotary disc, and a second conveyor belt, wherein the second gear is connected with the first rotary disc, the third gear is connected with the second rotary disc, the first rotary disc is in transmission connection with the second rotary disc through the second conveyor belt, and the second gear is engaged with the second wheel, and the third gear is applied to connecting with the second cleaning member.

In some embodiments, wherein the second driven member further includes a fourth gear, wherein the fourth gear is engaged with the third gear, and the fourth gear is connected with the second cleaning member, so that the third gear is connected with the second cleaning member through the fourth gear.

In some embodiments, wherein the second driven member further includes a fifth gear, wherein the fifth gear is configured between the third gear and the fourth gear, and the fifth gear is engaged with the third gear, and the fifth gear is engaged with the fourth gear.

In some embodiments, wherein the first driven member includes a sixth gear and a seventh gear, wherein the sixth gear is engaged with the second wheel, the sixth gear is engaged with the seventh gear, and the seventh gear is connected with the first cleaning member.

In some embodiments, wherein the first driven member further includes an eighth gear, wherein the eighth gear is configured between the sixth gear and the seventh gear, and the eighth gear is engaged with the sixth gear, and he eighth gear is engaged with the seventh gear.

In some embodiments, wherein the first cleaning member is a rolling brush for cleaning ground, and the second cleaning member is a rolling brush for cleaning water surface.

In some embodiments, wherein the pool cleaning robot includes two transmission devices, two first wheels, and two second wheels, wherein each of the two transmission devices includes at least one first driven member, at least one driving member, and at least one second driven member.

In some embodiments, wherein the pool cleaning robot includes four transmission devices, two first wheels, and two second wheels, wherein each of the four transmission devices includes one first driven member and one driving member.

### BRIEF DESCRIPTION OF THE DRAWINGS

In order to describe the technical solutions in the examples of the present disclosure more clearly, the accompanying drawings required for describing the examples of the present disclosure are briefly described below. Obviously, the accompanying drawings in the following description are merely some examples of the present disclosure, and those of ordinary skill in the art can also derive other accompanying drawings from the contents in the examples of the present disclosure and these accompanying drawings without making creative efforts.

FIG. 1 illustrates a schematic structural diagram of a pool cleaning robot according to some embodiments of the present disclosure; and

FIG. 2 illustrates an exploded diagram of a pool cleaning robot according to some embodiments of the present disclosure.

### REFERENCE NUMERALS

100. body;
200. driving member; 210. first gear;
300. wheel assembly; 310. first wheel; 320. second wheel; 330. conveyor belt;
400. first driven member; 410. sixth gear; 420. seventh gear; 430. eighth gear; 440. first cleaning member;
500. second driven member; 510. second gear; 520. third gear; 530. conveyor belt; 540. fourth gear; 550. fifth gear; and 560. second cleaning member.

### DETAILED DESCRIPTION OF THE EMBODIMENTS

The present disclosure will be further described in detail below with reference to the accompanying drawings and examples. It can be understood that the specific examples described herein are merely used to explain the present disclosure, rather than to limit the present disclosure. In addition, it is further to be noted that for the convenience of description, only some structures related to the present disclosure rather than all structures are shown in the accompanying drawings.

In the description of the present disclosure, unless otherwise explicitly specified and limited, the terms “connected”, “connection”, and “fixed” should be understood in a broad sense. For example, a connection can be a fixed connection, a detachable connection, an integrated connection, a mechanical connection, an electric connection, a direct connection, an indirect connection via an intermediate medium, communication of structures inside two elements, or an interaction relation of two elements. For those of ordinary skill in the art, the specific meanings of the above terms in the present disclosure can be understood according to specific conditions.

In the present disclosure, unless otherwise explicitly specified and limited, a first feature is “on” or “underneath” a second feature can include that the first feature and the second feature are in direct contact, or in indirect contact through another feature therebetween. Moreover, the first feature is “on”, “above”, and “over” the second feature includes that the first feature is right above or obliquely above the second feature, or merely indicates that the first feature has a higher level than the second feature. The first feature is “underneath”, “below”, and “under” the second feature includes that the first feature is right below or obliquely below the second feature, or merely indicates that the first feature has a lower level than the second feature.

In the description of the present disclosure, the orientation or position relations indicated by the terms “upper”, “lower”, “left”, “right”, etc. are based on the orientation or position relations shown in the accompanying drawings, merely for facilitating the description and simplifying the operation, rather than indicating or implying that a device or element referred to must have a particular orientation or be constructed and operated in a particular orientation, and therefore cannot be interpreted as limiting the present disclosure. In addition, the terms “first” and “second” are merely used to distinguish in description and have no special meanings.

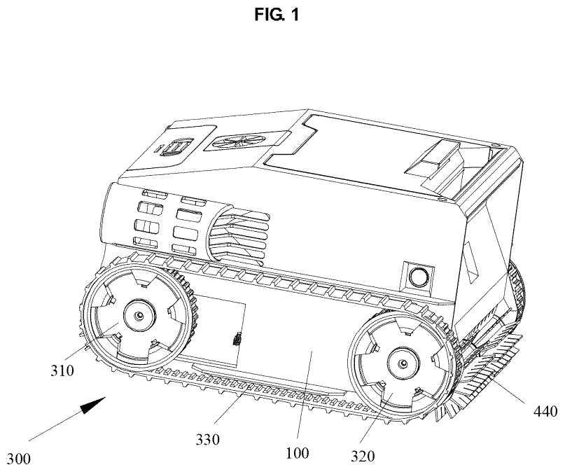

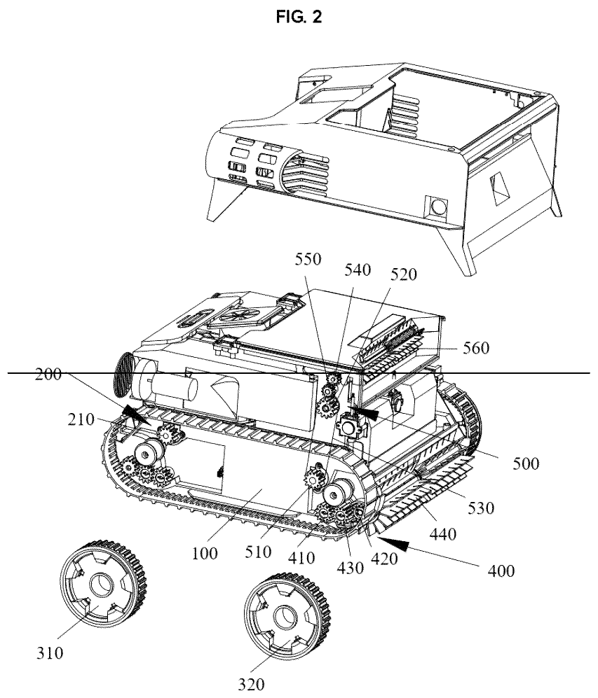

As shown in FIGS. 1-2, a transmission device is provided in the example. The transmission device is applied to a pool cleaning robot. The pool cleaning robot includes a body 100, a wheel assembly 300, a first cleaning member 440, and a second cleaning member 560. The transmission device is configured on the body 100. The transmission device mainly includes a driving member 200, a first driven member 400, and a second driven member 500. The driving member 200 is configured inside the body 100, where an output end of the driving member 200 is configured to be in driving connection with the wheel assembly 300, so that the driving member 200 is capable of driving the wheel assembly 300 to rotate. The first driven member 400 is configured on the body 100, and the first driven member 400 is in driving connection with the wheel assembly 300, where an output end of the first driven member 400 is configured to be connected with the first cleaning member 440, and the wheel assembly 300 drives the first driven member 400 to rotate, so that the first driven member 400 drives the first cleaning member 440 to rotate. The second driven member 500 is configured on the body 100, and the second driven member 500 is in driving connection with the wheel assembly 300, where an output end of the second driven member 500 is configured to be connected with the second cleaning member 560, and the wheel assembly 300 drives the second driven member 500 to rotate, so that the second driven member 500 drives the second cleaning member 560 to rotate.

Exemplarily, the first cleaning member 440 is a ground cleaning rolling brush, namely, the first cleaning member 440 is a rolling brush for cleaning ground; and the second cleaning member 560 is a water surface cleaning rolling brush, namely, the second cleaning member 560 is a rolling brush for cleaning water surface.

According to the transmission device according to the example, the driving member 200, the first driven member 400, and the second driven member 500 are configured, so that only one driving member 200 is required to drive the wheel assembly 300, the first cleaning member 440, and the second cleaning member 560, with a simple driving structure and a low manufacturing cost. The driving member 200 drives the wheel assembly 300 to rotate, so that the wheel assembly 300 moves forwards or backwards. The wheel assembly 300 can drive the first driven member 400 and the second driven member 500 to rotate during rotation, and the first driven member 400 and the second driven member 500 drive the first cleaning member 440 and the second cleaning member 560 to rotate, respectively. Therefore, different cleaning members can work, and cleaning functions of the pool cleaning robot can be diversified. Exemplarily, when the first cleaning member 440 is the ground cleaning rolling brush and the second cleaning member 560 is the water surface cleaning rolling brush, the transmission device can drive the ground cleaning rolling brush and the water surface cleaning rolling brush to rotate by driving the wheel assembly 300 to rotate. Therefore, the cleaning functions of the pool cleaning robot can be diversified.

In the example, the wheel assembly 300 includes a first wheel 310, a second wheel 320, and a conveyor belt 330, where the first wheel 310 is in transmission connection with the second wheel 320 through the conveyor belt 330, and the output end of the driving member 200 is in driving connection with the first wheel 310. Specifically, in the example, two first wheels 310 and two second wheels 320 are provided, the two first wheels 310 are configured on a front end of the body 100, and the two second wheels 320 are configured on a rear end of the body 100.

Exemplarily, the driving member 200 includes an electric motor, and the transmission device further includes a first gear 210. An output end of the electric motor is connected with the first gear 210, and the first gear 210 is engaged with the first wheel 310, so that the first gear 210 can drive the first wheel 310 to rotate. In addition, the driving member 200 may also be configured as other components capable of providing kinetic energy, which will not be limited in the example.

As shown in FIGS. 1-2, in the example, the second driven member 500 includes a second gear 510, a third gear 520, a fourth gear 540, a fifth gear 550, and a first rotary disc, a second rotary disc and a second conveyor belt 530. The second gear 510 is connected with the first rotary disc, the third gear 520 is connected with the second rotary disc, and the first rotary disc is in transmission connection with the second rotary disc through the second conveyor belt 530. The second gear 510 is engaged with the second wheel 320. The fourth gear 540 is engaged with the third gear 520, and the fourth gear 540 is connected with the second cleaning member 560. The fifth gear 550 is configured between the third gear 520 and the fourth gear 540, and the fifth gear 550 is engaged with the third gear 520, and the fifth gear 550 is engaged with the fourth gear 540.

Specifically, during working, after the driving member 200 is activated, the driving member 200 drives the first gear 210 to rotate. Since the first gear 210 is engaged with the first wheel 310, the first gear 210 can drive the first wheel 310 to rotate. Under the connection through the conveyor belt 330, the first wheel 310 can drive the second wheel 320 to rotate through the conveyor belt 330, the second wheel 320 drives the second gear 510 to rotate, and the second gear 510 drives the first rotary disc to rotate. Therefore, the first rotary disc drives the second rotary disc to rotate through the conveyor belt 530, the second rotary disc drives the third gear 520 to rotate, the third gear 520 drives the fifth gear 550 to rotate, and the fifth gear 550 drives the fourth gear 540 to rotate. Finally the fourth gear 540 can drive the second cleaning member 560 to rotate. When the second cleaning member 560 is the water surface cleaning rolling brush, the pool cleaning robot can clear and store garbage on a water surface.

In some alternative embodiments, the second cleaning member 560 is connected with the fourth gear 540 through a first connection shaft. In the example, the second driven member 500 is only configured on one side of the body 100, thereby simplifying the structure of the pool cleaning robot, saving on a cost, and reducing a weight.

Further, in the example, the second gear 510 is configured coaxial with the first rotary disc, the third gear 520 is configured coaxial with the second rotary disc, and the second rotary disc is configured right above the first rotary disc. In this way, the conveyor belt 530 can be shortened as much as possible, thereby saving on the cost and improving the reliability and stability of the second driven member 500.

As shown in FIGS. 1-2, in the example, the first driven member 400 includes a sixth gear 410, a seventh gear 420, and an eighth gear 430. The sixth gear 410 is engaged with the seventh gear 420, the sixth gear 410 is engaged with the second wheel 320, and the seventh gear 420 is connected with the first cleaning member 440. The eighth gear 430 is configured between the sixth gear 410 and the seventh gear 420, and the eighth gear 430 is engaged with the sixth gear 410, and the eighth gear 430 is engaged with the seventh gear 420.

Specifically, during working, after the driving member 200 is activated, the driving member 200 drives the first gear 210 to rotate. Since the first gear 210 is engaged with the first wheel 310, the first gear 210 can drive the first wheel 310 to rotate. Under the connection through the conveyor belt 330, the first wheel 310 can drive the second wheel 320 to rotate through the conveyor belt 330, the second wheel 320 drives the sixth gear 410 to rotate, the sixth gear 410 drives the eighth gear 430 to rotate, and the eighth gear 430 drives the seventh gear 420 to rotate. Therefore, the seventh gear 420 can drive the first cleaning member 440 to rotate. When the first cleaning member 440 is the ground cleaning rolling brush, the pool cleaning robot can clean a surface of a pool. The surface of the pool may be a bottom surface or a wall surface of the pool.

Further, with reference to FIG. 2 continuously, the first cleaning member 440 is connected with the seventh gear 420 through a second connection shaft, and the seventh gear 420 is detachably connected with the body 100 through a bolt. In this way, the first cleaning member 440 is replaced conveniently at a later stage. The sixth gear 410, the seventh gear 420, and the eighth gear 430 are configured, and the first cleaning member 440 is detachable on the premise of ensuring the normal operation of the first cleaning member 440. Therefore, the problem that the first cleaning member 440 is directly and fixedly connected with the second wheel 320 and cannot be detached in the conventional art is avoided, the flexibility and applicability of the pool cleaning robot in the example are improved, and the cost is saved on.

A pool cleaning robot is further provided in the example. The pool cleaning robot includes a body 100, a first cleaning member 440, a second cleaning member 560, a wheel assembly 300 and the above transmission device, where the transmission device is configured on the body 100. Different cleaning members can be driven through one driving member 200, and thus the pool cleaning robot has the diversified cleaning functions, a simple structure, a low manufacturing cost, and a light weight. A user can take and carry the pool cleaning robot conveniently, and a working efficiency is improved. Specifically, the first cleaning member 440 may be a ground cleaning rolling brush, and the second cleaning member 560 may be a water surface cleaning rolling brush. The transmission device of the pool cleaning robot can drive the ground cleaning rolling brush and the water surface cleaning rolling brush to rotate by driving the wheel assembly to rotate. Therefore, the cleaning functions of the pool cleaning robot can be diversified.

Furthermore, in the example, the pool cleaning robot includes two transmission devices, two first wheels 310, and two second wheels 320. Each transmission device includes at least one first driven member 400, at least one driving member 200, and at least one second driven member 500.

In a particular embodiment, each transmission device includes one first driven member 400, so that the pool cleaning robot includes two first driven members 400. The two first driven members 400 are configured on two sides of the body 100, respectively, and the two first driven members 400 are positioned at positions corresponding to the two second wheels 320, respectively. In the example, the pool cleaning robot includes two first cleaning members 440. That is, two seventh gears 420 independently drive each one first cleaning member 440, thereby improving a cleaning efficiency. The first cleaning member 440 may be a ground cleaning rolling brush, so that the pool cleaning robot can clean a surface of a pool. The surface of the pool may be a bottom surface or a wall surface of the pool.

In a particular embodiment, each transmission device includes one driving member 200, so that the pool cleaning robot includes two driving members 200. The two driving members 200 are each in driving connection with one first wheel 310. In this way, the pool cleaning robot realizes a turning action conveniently. The first wheel 310 may be a front wheel of the pool cleaning robot, and the second wheel 320 may be a rear wheel of the pool cleaning robot. Exemplarily, when the pool cleaning robot is required to turn, one driving member 200 stops or decelerates working of one first wheel 310, and the other driving member 200 accelerates to drive the other first wheel 310 to rotate. Therefore, the pool cleaning robot realizes the turning action. In the example, the two driving members 200 drive the two first wheels 310 to rotate, respectively. Therefore, more power can be provided for the pool cleaning robot, thereby improving the working efficiency.

In another example, the pool cleaning robot includes two transmission devices, two first wheels 310, and two second wheels 320. Each transmission device includes two first driven members 400, so that the pool cleaning robot has four first driven members 400. The four first driven members 400 are in driving connection with the two first wheels 310 and the two second wheels 320, respectively. Therefore, the four first driven members 400 drive the four first cleaning members 440, respectively. thereby improving a cleaning efficiency of the pool cleaning robot.

In yet another example, the pool cleaning robot includes four transmission devices, two first wheels 310, and two second wheels 320. Each transmission device includes one first driven member 400 and one driving member 200. Four driving members 200 drive the two first wheels 310 and the two second wheels 320, respectively. Four first driven members 400 are in driving connection with the two first wheels 310 and the two second wheels 320, respectively. Therefore, the four first driven members 400 drive four first cleaning members 440, respectively, thereby improving a cleaning efficiency of the pool cleaning robot.

It should be noted that the basic principles, main features, and advantages of the present disclosure are shown and described above. Those skilled in the art should understand that the present disclosure is not limited to the above embodiments, and the above embodiments and the descriptions in the description are merely illustrative of the principles of the present disclosure. Various changes and improvements can also be made to the present disclosure without departing from the spirit and scope of the present disclosure. These changes and improvements fall within the claimed scope of the present disclosure. The claimed scope of the present disclosure is defined by the appended claims and their equivalents.

What is claimed is:

1. A transmission device, the transmission device is applied to a pool cleaning robot, and the transmission device comprises:
a driving member, wherein an output end of the driving member is configured to be in driving connection with a wheel assembly of the pool cleaning robot, so that the driving member is capable of driving the wheel assembly to rotate; and
a first driven member, wherein the first driven member is in driving connection with the wheel assembly, an output end of the first driven member is configured to be connected with a first cleaning member of the pool cleaning robot, and the wheel assembly drives the first driven member to rotate, so that the first driven member drives the first cleaning member to rotate; and
a second driven member, wherein the second driven member is in driving connection with the wheel assembly, an output end of the second driven member is configured to be connected with a second cleaning member of the pool cleaning robot, and the wheel assembly drives the second driven member to rotate, so that the second driven member drives the second cleaning member to rotate.

2. The transmission device as claimed in claim 1, wherein the wheel assembly comprises a first wheel, a second wheel, and a first conveyor belt, wherein the first wheel is in transmission connection with the second wheel through the first conveyor belt, and the output end of the driving member is in driving connection with the first wheel.

3. The transmission device as claimed in claim 2, wherein the transmission device further comprises a first gear, wherein the output end of the driving member is connected with the first gear, and the first gear is engaged with the first wheel.

4. The transmission device as claimed in claim 2, wherein the second driven member comprises a second gear, a first rotary disc, a third gear, a second rotary disc, and a second conveyor belt, wherein the second gear is connected with the first rotary disc, the third gear is connected with the second rotary disc, the first rotary disc is in transmission connection with the second rotary disc through the second conveyor belt, and the second gear is engaged with the second wheel, and the third gear is applied to connecting with the second cleaning member.

5. The transmission device as claimed in claim 4, wherein the second gear is configured coaxial with the first rotary disc, and the third gear is configured coaxial with the second rotary disc.

6. The transmission device as claimed in claim 4, wherein the second driven member further comprises a fourth gear, wherein the fourth gear is engaged with the third gear, and the fourth gear is connected with the second cleaning member, so that the third gear is connected with the second cleaning member through the fourth gear.

7. The transmission device as claimed in claim 6, wherein the second driven member further comprises a fifth gear, wherein the fifth gear is configured between the third gear and the fourth gear, and the fifth gear is engaged with the third gear, and the fifth gear is engaged with the fourth gear.

8. The transmission device as claimed in claim 2, wherein the first driven member comprises a sixth gear and a seventh gear, wherein the sixth gear is engaged with the second wheel, the sixth gear is engaged with the seventh gear, and the seventh gear is connected with the first cleaning member.

9. The transmission device as claimed in claim 8, wherein the first driven member further comprises an eighth gear, wherein the eighth gear is configured between the sixth gear and the seventh gear, and the eighth gear is engaged with the sixth gear, and he eighth gear is engaged with the seventh gear.

10. A pool cleaning robot, the pool cleaning robot comprises a body, a first cleaning member, a second cleaning member, a wheel assembly and a transmission device, wherein the transmission device is configured on the body, and the transmission device comprises:
a driving member, wherein an output end of the driving member is configured to be in driving connection with the wheel assembly, so that the driving member is capable of driving the wheel assembly to rotate; and
a first driven member, wherein the first driven member is in driving connection with the wheel assembly, an output end of the first driven member is configured to be connected with the first cleaning member, and the wheel assembly drives the first driven member to rotate, so that the first driven member drives the first cleaning member to rotate: and
a second driven member, wherein the second driven member is in driving connection with the wheel assembly, an output end of the second driven member is configured to be connected with the second cleaning member, and the wheel assembly drives the second driven member to rotate, so that the second driven member drives the second cleaning member to rotate.

11. The pool cleaning robot as claimed in claim 10, wherein the wheel assembly comprises a first wheel, a second wheel, and a first conveyor belt, wherein the first wheel is in transmission connection with the second wheel through the first conveyor belt, and the output end of the driving member is in driving connection with the first wheel.

12. The pool cleaning robot as claimed in claim 11, wherein the transmission device further comprises a first gear, wherein the output end of the driving member is connected with the first gear, and the first gear is engaged with the first wheel.

13. The pool cleaning robot as claimed in claim 11, wherein the second driven member comprises a second gear, a first rotary disc, a third gear, a second rotary disc, and a second conveyor belt, wherein the second gear is connected with the first rotary disc, the third gear is connected with the second rotary disc, the first rotary disc is in transmission connection with the second rotary disc through the second conveyor belt, and the second gear is engaged with the second wheel, and the third gear is applied to connecting with the second cleaning member.

14. The pool cleaning robot as claimed in claim 13, wherein the second driven member further comprises a fourth gear, wherein the fourth gear is engaged with the third gear, and the fourth gear is connected with the second cleaning member, so that the third gear is connected with the second cleaning member through the fourth gear.

15. The pool cleaning robot as claimed in claim 14, wherein the second driven member further comprises a fifth gear, wherein the fifth gear is configured between the third gear and the fourth gear, and the fifth gear is engaged with the third gear, and the fifth gear is engaged with the fourth gear.

16. The pool cleaning robot as claimed in claim 11, wherein the first driven member comprises a sixth gear and a seventh gear, wherein the sixth gear is engaged with the second wheel, the sixth gear is engaged with the seventh gear, and the seventh gear is connected with the first cleaning member.

17. The pool cleaning robot as claimed in claim 16, wherein the first driven member further comprises an eighth gear, wherein the eighth gear is configured between the sixth gear and the seventh gear, and the eighth gear is engaged with the sixth gear, and he eighth gear is engaged with the seventh gear.

18. The pool cleaning robot as claimed in claim 10, wherein the first cleaning member is a rolling brush for cleaning ground, and the second cleaning member is a rolling brush for cleaning water surface.

19. The pool cleaning robot as claimed in claim 11, wherein the pool cleaning robot comprises two transmission devices, two first wheels, and two second wheels, wherein each of the two transmission devices comprises at least one first driven member, at least one driving member, and at least one second driven member.

20. The pool cleaning robot as claimed in claim 11, wherein the pool cleaning robot comprises four transmission devices, two first wheels, and two second wheels, wherein each of the four transmission devices comprises one first driven member and one driving member.
